(19) United States
(12) Patent Application Publication
(10) Pub. No.: US 2004/0099202 A1
(43) Pub. Date: May 27, 2004

(54) Identification attachment for gauge

(76) Inventor: Jeffrey T. Blake, Milford, CT (US)

Correspondence Address: FISH & RICHARDSON P.C., 5000 BANK ONE CENTER, 1717 MAIN STREET, DALLAS, TX, 75201, US

(21) Appl. No.: 10/302,233

(22) Filed: Nov. 22, 2002

(51) Int. Cl. G09F 3/00

(52) U.S. Cl. 116/201

(57) ABSTRACT

A preformed molded colored shell adapted to be placed on case of a gauge, such as a pressure gauge. Cutouts allow the shell to be installed or removed without removing the gauge from service. A predetermined action may be taken based on the color of the shell. The shell provides a simplified means of identifying the pressure gauge. The shell can be adapted to comprise any one, or more, of a plurality of colors. A greater variety of colors can be imparted to the case than is available when integrating color into a phenolic case. The shell can thereby provide a true color to a case, whereas phenolic colored cases comprise a black hue. Thus, an identification system comprising a plurality of different colored shells is provided.

### FIELD OF THE INVENTION

The present invention relates generally to gauges and more particularly to pressure gauges. Particular embodiments relate to identification of pressure gauges.

### BACKGROUND OF THE INVENTION

Pressure gauges are used in a variety of applications to measure the pressures of known fluids. The pressure gauge typically comprises a phenolic case, also known by its brand name BAKELIGHT. Additional information concerning pressure gauges may be found in U.S. Pat. Nos. 5,481,921, 5,988,303, 6,085,595 and 6,216,541, all of which are incorporated herein by reference in their entireties.

Many processes are simplified when using a colored gauge case. But conventional pressure gauge cases, i.e., phenolic cases, are typically only available in black. When cases are available in a color other than black, there are generally only a limited number of colors from which to select a colored phenolic case, namely red, blue and green colors. Another significant disadvantage with colored phenolic cases is that when one of the limited selection of colors is potentially acceptable, the colored cases still have a black appearance that distorts the color. For example, the supposedly red phenolic case appears more brown than red and the blue phenolic case appears more gray than blue.

Painting has been used to obtain a greater color selection. And painting is an acceptable alternative for some applications. But one significant disadvantage with painting is that paint chips may, over time, flake off of the gauge. Thus, painting is not an acceptable alternative for many applications. Another significant disadvantage with painting is the attendant costs. Painting each case is labor intensive, and therefore each painted case is more costly. Furthermore, the process of painting cases generally requires that plant facility space be allocated for both painting and drying phases of the process. This facility cost must be added to the labor costs.

Another coloring alternative related to painting is utilization of a rubber paint. The rubber paint is generally not prone to the peeling and chipping problems of conventional paints. In use, the colored rubberized material is sprayed on the gauges and allowed to cure. Disadvantages with this method include a relatively longer cure time, a small selection of colors and an inability to remove the rubberized coating from the gauge after it has cured. Plant facility costs are at least as high as those associated with conventional painting processes.

Clearly, other alternatives for color coding gauges is needed.

### SUMMARY OF THE INVENTION

An embodiment of the invention consists of a molded color shell that may be placed over the outside of a pressure gauge case. The shell is preferably removably securable to the case. Methods for removably securing the shell comprise, for example: preforming the shell to snugly fit on the case; providing the shell with snaps or one or more resilient members to interface the case; using adhesive; using bonding composition; using screws or other fasteners. Preferably the shell comprises cut-outs that allow the shell to be installed or removed from the gauge without removing the gauge from the service. The one or more cut-outs can be sized to fit with, for example, inlet stems of the pressure gauges.

The invention also comprises a method of identification using the shell. Information associated with a pressure gauge is obtained and, based on the information obtained, a determination is made as to whether or not the pressure gauge should be identified, e.g., flagged, for subsequent servicing. If the pressure gauge should be identified, the preformed shell may be placed around the pressure gauge, whereby the pressure gauge is identified. The pressure gauge may, thus, subsequently be readily located. The shell is preferably provided with structure for conveying information. Such structure can be based on use of symbolic methods, e.g., color, pictograms, or data transmission. Data transmission, in simple form, may take the form of a placard extending from the shell, where the placard may comprise text.

In one of the many embodiments of the invention, the preformed shell may be selected from a plurality of colors such that the color selected is associated with the information obtained. Accordingly, non-selected colors would typically be associated with information that did not correspond to the information obtained. Action may then be taken based on the color selected. Each color of the plurality of available colors can be associated with one or more predetermined actions. Such action can include, for example, monitoring the gauge or repairing the or another predetermined action. For some applications, the party taking action, e.g., repairing the gauge, will know which information to re-acquire to test the gauge. In other applications, there is no need to re-acquire the previously obtained information. For example, based on a complex set of criteria, a supervisor may flag a gauge for monitoring of pressure. The individual monitoring the gauge in response to the flagging of the gauge does not need to learn the complex set of criteria or repeat the analysis, but only monitor the gauge. Similarly, an abnormally operating gauge may be flagged for more thorough testing by a specialist.

One identification method comprises identifying a pressure gauge that is exhibiting abnormal operation. The pressure gauge is identified by placement of a shell on the pressure gauge. The abnormal operation may be, for example, the pressure gauge is failing or the fluid appears to be exhibiting abnormal fluctuations in pressure. A second individual locates the gauge in need of service by looking for the shell. For some applications, both speed and convenience are increased through use of a preformed shell comprising a non-black color.

One embodiment comprises a device for a pressure gauge. For some applications, the device comprises a preformed shell having a predetermined shape adapted to engauge the case of the pressure gauge. The shell may comprise a non-black visible color, which is preferably integral with the shell. The integral color provides the shell with a true color, in contrast to the black hued casings of current colored phenolic cases. For some applications the shell comprises one or more resilient members adapted to releasably secure the shell to the case. Cut-outs are preferably provided in the shell to allow the shell to be attached to and removed from a pressure gauge without removing the pressure gauge from service.

### BRIEF DESCRIPTION OF THE DRAWINGS

In the drawings:

FIG. 1 shows a perspective view of an identification system comprising a plurality of a preformed shells for identifying a pressure gauge.

FIG. 2 shows a cut-away cross section of one of the shells depicted in FIG. 1, but secured to the case.

FIG. 3 shows the partial view of the shell of FIG. 2 rotated clockwise to better show part of a resilient lip for releasably securing the shell to the case.

FIG. 4 shows a cross section view of a shell similar to the shell shown in FIG. 2, but secured to the case with an adhesive.

### DETAILED DESCRIPTION OF THE ILLUSTRATED EMBODIMENT

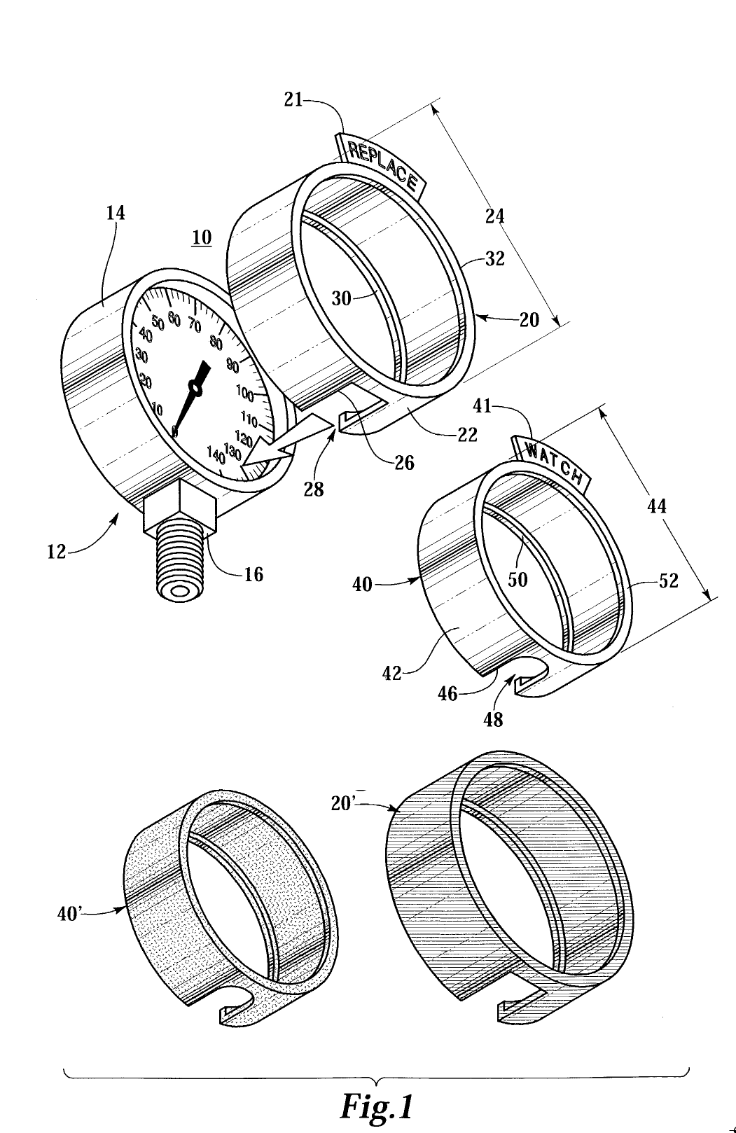

FIG. 1 illustrates an identification system 10 for a pressure gauge 12. Pressure gauge 12 comprises a case 14, which is black. An inlet stem 16 extends from the case 14. The illustrated inlet stem is a block-type interface.

The system 10 comprises a plurality of shells, including a first shell 20 adapted to engage the case 14. The first shell 20 comprises a placard 21 extending therefrom and adapted to convey information. For some applications the first shell 20 is a molded preformed shell comprising a generally circular shape size to fit the case 14. Other shapes will be appropriate for different applications. Similarly, an alternate shell 20′ is substantially the same as the first shell 20, but is a first non-black color. Shell 20′ is illustrated to be a blue color, but other colors are suitable. The first shell 20 comprises a generally cylindrical wall 22 having a first diameter 24 adapted to fit the case 14. The generally cylindrical wall 22 comprises one or more edges 26 defining a cut out 28. The cut out 28 is adapted to fit with the block-style inlet stem 16, thereby allowing the first shell 20 to be placed on the pressure gauge 12. In contrast, a second shell 40 (and shell 40′) is adapted to fit a round-style inlet stem.

In some embodiments, the first shell 20 is resilient and adapted to snuggly fit the case 14 such that it is a releasably secured to the case 14. In some applications, the first shell 20 comprises one or more resilient members, such as first lip 30 and second lip 32. The first shell 20 need not comprise first and second lips 30 and 32 to be releasably secured to the case 14. A variety of structure for releasably securing the first shell 20 to the case 14 will be suitable.

In some applications, the first shell 20 is bonded to the case 14 with an adhesive (See FIG. 4 illustrating an alternate embodiment). The adhesive may be of the permanent type for fixably securing the first shell 20 to the case 14, or the temporary type for releasably securing the first shell 20 to the case 14. When resilient members are used to releasably secure the first shell 20 to the case 14, members other than lips are acceptable; and if lips are used, a lip is not required to form a single continuous ring.

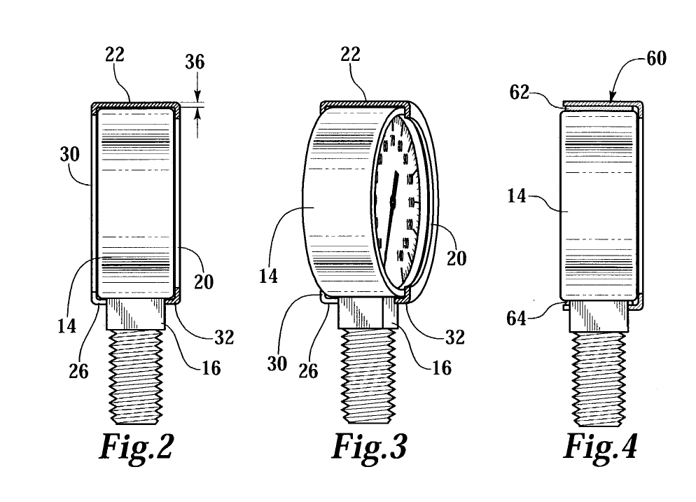

A significant advantage achieved by application of the teachings herein is the ability to quickly impart color to a case of a gauge. To impart color to the case, the shell generally has a minimum thickness when installed. Turning to FIG. 2, which is a side partial section view through the first shell 20, some embodiments use a shell 20 comprising a thickness 36 of not more than about 0.0060 inch and not less than about 0.0005 inch. In some applications, the shell thickness 36 is between about 0.0025 inch and about 0.0030 inch when the shell 20 is engaging the case 14. Such thicknesses are generally sufficient to impart a non-black color to a black gauge. FIG. 3 depicts the case 14 and shell 20 illustrated in FIG. 2, but rotated clockwise to better illustrate the second lip 32.

Returning to FIG. 1, some embodiments of the system 10 comprise a second shell 40. An alternate shell 40′ substantially identical to the second shell 40 is illustrated with a second different non-black color, namely, orange. The second shell 40 has a generally cylindrical wall 42 and a diameter 44. One or more edges 46 define a cut out 48. Cut out 48 is adapted to fit a round style inlet stem. First and second lips 50 and 52 may be used to releasably secure the shell 40 to the pressure gauge 12. Placard 41 extending from the cylindrical wall 42 indicates the gauge should be monitored rather than replaced, as does placard 21.

FIG. 4 illustrates a partial section view of a third shell 60 in which the first lip has been removed and the shell 60 has been secured to the pressure gauge case 14 by adhesive 62. Adhesive 62 may be placed at a plurality of locations about the parameter of the shell, e.g., reference number 64. Adhesive may also be placed continuously about the inside of the wall of the shell 60.

The illustrated system 10 is only an exemplary embodiment. The shells can be provided with any variety of cut outs (e.g., 28 and 48) to attached the shell to a case 14. The shell also can be adapted to be narrow enough to not require the use of cut out or be adapted to only partially wrap around the case 14. And a significant advantage of the system 10 is that the shells can be formed with a wide variety of colors, thereby providing a much greater selection of colors to impart to a case than presently available with current phenolic cases. One of ordinary skill in the art will also appreciate the ability to impart a true color to a case, rather than one of the false colors (i.e., black-hued colors) from the limited selection of false colors presently available for phenolic cases.

In accordance with the teachings herein, a pressure gauge may be identified in a cost efficient manner. Information associated with a pressure gauge may be obtained. Based on the information, a determination may be made as to whether or not the pressure gauge should be identified. If, based on the determination, the pressure gauge should be identified, a shell can be placed around the gauge, whereby the pressure gauge is identified. In some applications, it is desirable to be able to select the shell from a plurality of shells, wherein the shells are differentiated at least by color, e.g., one shell blue and another shell orange. The blue shell 20′ would be associated with a first set of information and the orange shell 40′ would be associated with a second different set of information. After obtaining the information associated with the pressure gauge, and determining that the pressure gauge should be identified, the shell having a color associated with the obtained information may then be selected and attached to the gauge.

The pressure gauge, having been identified, may be subsequently attended to based on the shell having been placed on the pressure gauge. The manner in which the pressure gauge is attended to may be based on the color of the shell. For example, the blue shell 20′ may require an individual to service or replace the pressure gauge, whereas the orange shell 40′ may indicate the pressure is exhibiting abnormal behavior and should be watched. One needing to service the pressure gauge may readily locate the pressure gauge by looking for the blue shell. Having located the blue shell, the pressure gauge to be serviced is identified. After the pressure gauge is, for example, repaired, the shell can readily be removed, thereby indicating the pressure gauge is now operable.

Attaching a shell to a pressure gauge may also be used to identify fluid being monitored, or identify an operation or adjustment to the fluid, e.g., increasing or decreasing the pressure. Such identification may be based on the color of the shell.

A benefit of the invention is that it provides an interchangeable colored cover for a gauge that will allow the identification, or color coding, of a gauge, for example, a pressure gauge. Preferably, the cover may be attached either prior to or after installation of the gauge. A related benefit is the capability to identify the fluid measured by the gauge. This may be done by, for example, coding the gauge or the pipe containing the fluid.

Another benefit of the invention is the ability to reliably, yet simply, identify a pressure gauge that needs to be serviced. A related benefit is the capability of quickly locating the pressure gauge after it has been identified or flagged, by looking for the identification struction.

A related benefit of the invention is realized in a device that is easily attachable to and removable from the pressure gauge. Further benefits of the invention are realized through providing the removably-attachable device in a variety of colors. Predetermined actions may then be taken based on the color of the device attached to the gauge. Thus, one use of the invention is providing structure for removably securing a color-coded identification device to the pressure gauge.

Another use of the invention is to provide an identification device, e.g., a color-coded device acceptable for use in contamination sensitive processes. Such a device should not be prone to deterioration that will contaminate a sensitive process. For example, the device should not be prone to paint chipping.

Another benefit is obtaining a relatively large selection of color-coded devices or other devices for providing a variety of non-black gauge case visible colors, including the colors of red, blue, green, yellow and orange.

Other uses benefits and advantages will be apparent to those of ordinary skill in the art from the teachings herein with and without ordinary experimentation.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A method of identification comprising:
obtaining information associated with a pressure gauge;
based on the information obtained, determining if the pressure gauge should be identified; and
if the pressure gauge should be identified, placing a shell around the pressure gauge, whereby the pressure gauge is identified.

2. The method of claim 1, comprising selecting the shell from a plurality of preformed shells comprising the shell and at least one other shell, wherein the shell has a color and at least one other shell has a different color.

3. The method of claim 2, comprising selecting the preformed shell so the color of the selected preformed shell corresponds to the information obtained.

4. The method of claim 3, comprising attending to the pressure gauge based on the color of the preformed shell, wherein the information obtained is associated with functioning status of the pressure gauge.

5. The method of claim 4, wherein attending to the pressure gauge comprises monitoring the pressure gauge.

6. The method of claim 4, wherein attending to the pressure gauge comprises servicing the pressure gauge.

7. The method of claim 6, wherein servicing the pressure gauge comprises replacing the pressure gauge.

8. The method of claim 1, comprising attending to the pressure gauge if the shell is placed on the pressure gauge.

9. The method of claim 8, comprising removing the shell after attending to the pressure gauge.

10. The method of claim 8, wherein attending to the pressure gauge comprises monitoring fluid pressure according to a predetermined schedule, wherein the predetermined schedule corresponds to the shell placed on the pressure gauge.

11. The method of claim 10, comprising selecting the shell to be a color corresponding to the predetermined schedule.

12. The method of claim 1, comprising stretching the shell to fit around the pressure gauge.

13. The method of claim 12, wherein stretching the shell comprises allowing one or more resilient members to bend as the shell is fitted into position.

14. A method of identification comprising:
obtaining information associated with a pressure gauge;
assessing the obtained information to determine if the information indicates abnormal operation; and
if the information indicates abnormal operation, placing a shell around a case of the pressure gauge, whereby the pressure gauge is identified.

15. The method of claim 14, comprising selecting the shell to be a color corresponding to the information obtained.

16. The method of claim 15, comprising identifying a predetermined service to be performed on the pressure gauge based on the color of the shell placed on the pressure gauge.

17. The method of claim 15, comprising identifying an operation of fluid adjustment by selecting the color of the shell and placing the shell on the gauge.

18. The method of claim 15, comprising associating the obtained information with a predetermined activity to be carried out and selecting the color of the shell to identify the predetermined activity should be carried out.

19. The method of claim 18, comprising removing the shell from the pressure gauge after the predetermined activity is carried out.

20. The method of claim 14, comprising identifying a location associated with the pressure gauge, wherein the location is identified by placing the shell on the pressure gauge.

21. The method of claim 14, comprising removing the shell from the pressure gauge after performing a predetermined activity.

22. A method of identification comprising:
obtaining information associated with a gauge having a case,
selecting a shell adapted to removably attach to the case, wherein the shell is selected based on the obtained information associated with the case; and
attaching the shell to the case, whereby the pressure gauge is identified as having the obtained information associated therewith.

23. The method of claim 22, comprising stretching the shell to fit around the pressure gauge case.

24. A device for a pressure gauge having a case, the device comprising:
a shell adapted to engage the case; and
a non-black color integral with the shell, wherein the shell has a sufficient thickness when engaging the case to impart color to the case.

25. The device of claim 24, wherein the shell comprises a cut-out adapted to fit a component extending from the pressure gauge to allow the shell to be installed without removing the pressure gauge from service.

26. The device of claim 24, means for releasably securing the shell to the case.

27. The device of claim 26, wherein the means for releasably securing the shell to the case comprises one or more resilient lips adapted to couple the shell to case.

28. The device of claim 24, wherein the shell comprises a thickness not more than about 0.0060 inch and not less than 0.0005 inch.

29. The device of claim 28, wherein the shell thickness is between about 0.0025 inch and about 0.0030 inch when engaging the case.

30. The device of claim 24, wherein the shell is preformed and comprises a predetermined shape sized to snuggly fit the case, whereby the shell may be releasably secured to the case.

31. The device of claim 24, wherein the shell comprises one or more resilient members adapted to releasably secure the shell to the case.

32. The device of claim 24, wherein the non-black color is selected from a group consisting of red, green, blue, yellow and orange.

33. The device of claim 24, wherein the shell is preformed with one or more cut-outs to allow the shell to engage the case while the pressure gauge is in service.

34. The device of claim 24, wherein the shell is resilient.

35. The device of claim 34, wherein the resilient shell is preformed into a generally circular shape.

36. An identification system for a pressure gauge having a case, the system comprising:
a first preformed shell having a generally circular shape adapted to engage the case, wherein the first shell is resilient and a first non-black color; and
a second preformed shell having a generally circular shape, wherein the second shell is resilient and distinguishable from the first shell.

37. The system of claim 36, wherein the second shell is a second non-black color different from the first non-black color and the generally circular shape of the second shell is adapted to engage the case.

38. The system of claim 36, wherein the first shell generally circular shape has a first diameter and the second shell generally circular shape has a second diameter approximately equal to the first diameter.

39. The system of claim 36, wherein the first shell has a first cut-out and the second shell has a second cut-out essentially corresponding to the first cut-out.
